(19) United States
(12) Patent Application Publication
(10) Pub. No.: US 2012/0306807 A1
(43) Pub. Date: Dec. 6, 2012

(54) BIOSENSOR

(75) Inventor: Chang Geun AHN, Daejeon (KR)

(73) Assignee: Electronics and Telecommunications Research Institute, Daejeon (KR)

(21) Appl. No.: 13/475,845

(22) Filed: May 18, 2012

(30) Foreign Application Priority Data
May 30, 2011 (KR) 10-2011-0051174

(51) Int. Cl. G06F 3/044; G09G 3/36

(52) U.S. Cl. 345/174

(57) ABSTRACT

Disclosed is a biosensor, including: a biochip to which a probe molecule is fixed on a wall thereof and into which a target molecule is injected; and a capacitive touch panel for detecting a reaction of the probe molecule in the biochip and the injected target molecule.

### CROSS-REFERENCE TO RELATED APPLICATIONS

This application is based on and claims priority from Korean Patent Application No. 10-2011-0051174, filed on May 30, 2011, with the Korean Intellectual Property Office, the present disclosure of which is incorporated herein in its entirety by reference.

### TECHNICAL FIELD

The present disclosure relates to a biosensor, and more particularly, to a biosensor which detects a biomaterial on a biochip by using a touch panel of a mobile device driven in a capacitive manner.

### BACKGROUND

Most biosensors for detecting a specific target molecule (for example, protein, enzyme, and DNA) contained in a liquid biosample have a probe molecule fixed on a surface of a sensing part, and such a probe molecule is particularly bonded only to a specific target molecule to allow selective detection of a biomaterial.

Sensors for quantitatively detecting a bond between a target molecule and a probe molecule may be classified into optical sensors and electrical sensors. An optical sensor marks a light emitting material such as a fluorescent material, a phosphorescent material, and a color material on a target molecule bonded to a probe molecule on a sensing part and then detects an optical signal generated from the light emitting material. An electrical sensor fixes a probe molecule on a channel surface of a field effect transistor, and detects a channel current change due to charges of the target molecule generated when a target molecule is coupled to the fixed probe molecule.

The technologies according to the related art require a separate analysis apparatus for detecting and measuring a converted signal in addition to a sensing part for converting a bond of a target molecule and a probe molecule to an optical or electrical signal. That is, an optical sensor requires a large-scale analysis device equipped with an expensive optical system such as an optical scanner to detect a signal of a light emitting marker, and an electrical sensor requires a measuring unit for measuring a minute current change of several nA to several tens of nA at a high signal to noise ratio.

That is, the biosensor according to the related art inevitably requires a separate reader including a signal detecting/processing unit and an external display in addition to a sensing part, and it is difficult to implement such a reader with a portable and inexpensive system, which causes problems in terms of convenience, usability by a user, prompt diagnosis, and costs.

Meanwhile, there have been attempts to process and display a signal sensed by an external signal detector through a mobile device to improve the convenience and approach of a user, in which case an external signal detector is necessary to send and receive data through a wired or wireless communication with the mobile device.

### SUMMARY

The present disclosure has been made in an effort to provide a new biosensor which can detect a biomaterial on a biochip by using a touch panel of a mobile device driven in a capacitive manner without using a separate analysis apparatus anywhere and anytime.

An exemplary embodiment of the present disclosure provides a biosensor, including: a biochip to which a probe molecule is fixed on a wall thereof and into which a target molecule is injected; and a capacitive touch panel for detecting a reaction of the probe molecule in the biochip and the injected target molecule.

As described above, the present disclosure provides a biosensor which detects a biomaterial on a biochip by using a touch panel of a mobile device, allowing a user to confirm an analysis result promptly and conveniently anytime and anywhere and reducing costs for manufacturing and managing a separate reader.

The structure of the used biochip is also very simple, making it possible to produce a product at a low price, easily manufacture a product in a form of an array to allow easy expansion of the product, and make the product disposable.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1 and 2 are views for explaining a basic principle of a rechargeable capacitive touch panel.

FIG. 3 is a graph illustrating a change in a charging time of a rechargeable capacitive touch panel before and after a contact with a user.

FIG. 4 is a view illustrating a configuration of a biosensor according to a first exemplary embodiment of the present disclosure.

FIG. 5 is a view illustrating a configuration of a biosensor according to a second exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, an exemplary embodiment of the present disclosure will be described in detail with reference to the accompanying drawings. In the description of the present disclosure, a detailed description of known configurations and functions may be omitted to avoid obscure understanding of the present disclosure.

A biosensor according to the present disclosure is an apparatus which, when a touch panel of a mobile device driven in a capacitive manner contacts a portion of a human body (for example, a hand), detects a change in an electrostatic capacity externally generated when a desired target molecule is bonded to a probe molecule by using a principle where an entire electrostatic capacity change due to an electrostatic capacity of the human body is recognized by the mobile device in order to easily detect a biomaterial only with a biochip itself without using a special attachable device.

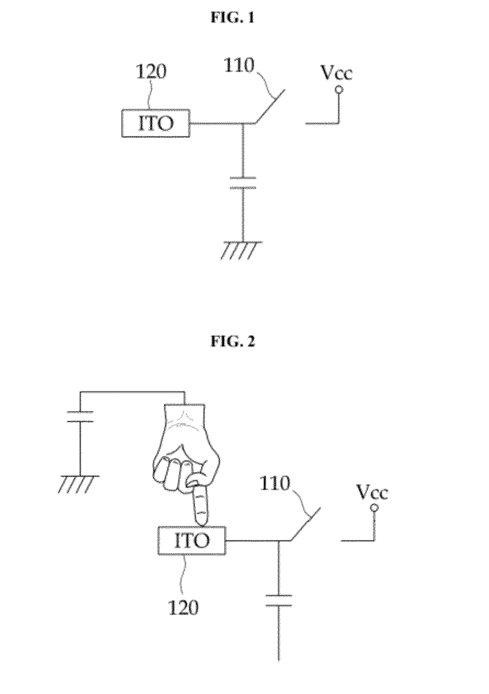

FIGS. 1 and 2 are views for explaining a basic principle of a rechargeable capacitive touch panel.

As shown in FIG. 1, if a switch 110 is closed, an indium tin oxide (ITO) film starts to be charged with electrostatic capacity. Then, a charging time is determined according to an electrostatic capacity of the ITO film 120. The charging time of the electrostatic capacity is important in a rechargeable capacitive touch panel.

Meanwhile, as illustrated in FIG. 2, if a hand of a user contacts the ITO film 120, a charging time of an electrostatic capacity increases due to the electrostatic capacity of the human body.

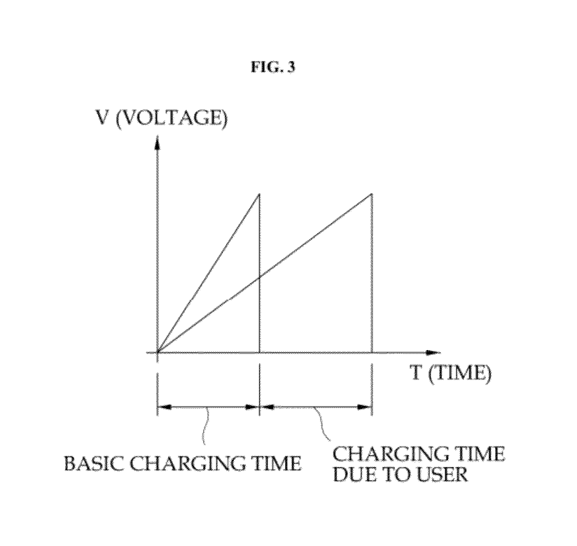

FIG. 3 is a graph illustrating a change in a charging time of a rechargeable capacitive touch panel before and after a contact with a user.

As illustrated in FIG. 3, if a charging time of an electrostatic capacity of a touch panel embedded in a mobile device when a user does not contact the touch panel is assumed to be a basic charging time, a charging time of an electrostatic capacity of a touch panel embedded in a mobile device when a user contacts the touch panel becomes longer than the basic charging time. Thus, it can be seen that an electrostatic capacity of the touch panel embedded in the mobile device is changed by a change in a charging time.

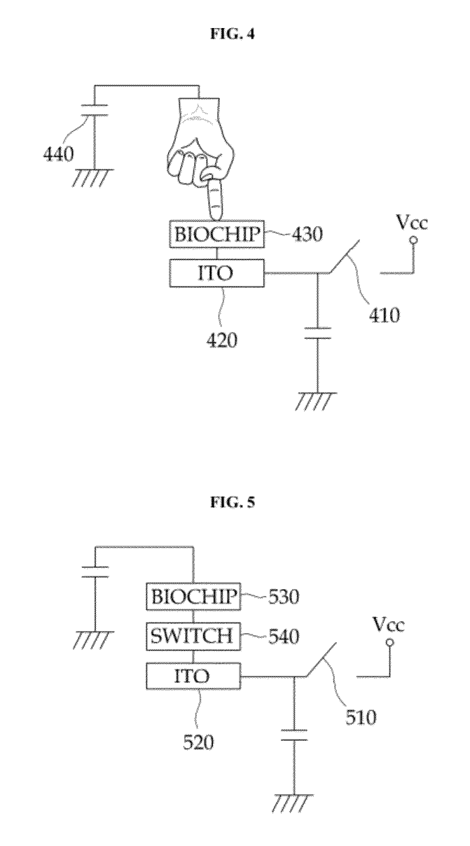

FIG. 4 is a view illustrating a configuration of a biosensor according to a first exemplary embodiment of the present disclosure.

Referring to FIG. 4, a biochip 430 is placed between an ITO film 420 which is a surface layer of a touch panel of a mobile device and a finger which is a contact portion of a human body. A probe molecule is fixed to an inner wall of the biochip 430, and a target molecule of, for example, blood, body fluid, and urine is injected into the biochip so that the probe molecule reacts with the target molecule. Here, the biochip 430 is designed such that a resistance thereof can change according to a reaction of the probe molecule and the target molecule and an electrostatic capacity of the human body is connected through the biochip 430 to influence the charging time when the target molecule is detected, making it possible to determine a reaction of the biochip 430. Then, the biochip 430 may be designed to represent a change in a resistance according to a reaction between the probe molecule and the target molecule due to irradiated light. That is, when light is irradiated, a resistance of the biochip 430 changes according to a reaction of the probe molecule and the target molecule, whereas when light is not irradiated, a resistance of the biochip 430 does not change even when the probe molecule and the target molecule react with each other. Thus, information regarding the reactions of the cells of the biochip 430 may be recognized through the difference between the charging times.

In the biosensor according to the present disclosure, as an equivalent capacitor of a human body capacitor 440 having a capacitance of a finger which is a contact portion of the human body is inserted into the biochip 430, a biomaterial can be analyzed even when the biochip 430 does not contact the finger.

The biochip 430 may be designed to cause a change in electrostatic capacity according to a degree of reaction. Then, a degree of reaction in the biochip 430 is quantified according to the charging time.

FIG. 5 is a view illustrating a configuration of a biosensor according to a second exemplary embodiment of the present disclosure.

Referring to FIG. 5, the biosensor according to the second exemplary embodiment of the present disclosure sequentially analyzes one or more biomaterials on one biochip 530. To this end, unlike the biosensor of FIG. 4, in the biosensor according to the second exemplary embodiment of the present disclosure, a switch 540 is present between an ITO film 520 and the biochip 530. The switch 540 is switched by light emitted from a liquid crystal display (LCD) of a touch panel. That is, if only a lower LCD of a desired biochip cell is switched on and light generated by the lower LCD penetrates, an upper switch of the lower LCD is also switched on so that the biosensor can be operated in the same way as that of the biosensor of FIG. 4. According to the above-described principle, information regarding the reactions of the cells of the upper biochip can be recognized according to a difference between the charging times while the lower LCD is sequentially switched on and off.

Accordingly, the biosensor according to the present disclosure can easily detect a biomaterial by, after injecting a target molecule of, for example, blood, body fluid, and urine into a biochip to which inner wall a probe molecule is fixed and reacting the injected target molecule with the probe molecule, placing the biochip on a surface of a touch panel of a mobile device. A structure of the biochip is very simple and low-priced, making it easier to make the biochip disposable.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A biosensor, comprising:
a biochip to which a probe molecule is fixed on a wall thereof and into which a target molecule is injected; and
a capacitive touch panel for detecting a reaction of the probe molecule in the biochip and the injected target molecule.

2. The biosensor of claim 1, wherein a resistance of the biochip is varied according to the reaction of the probe molecule and the injected target molecule.

3. The biosensor of claim 2, wherein the biochip represents a change in resistance according to the reaction of the probe molecule and the injected target molecule due to irradiated light.

4. The biosensor of claim 1, wherein an electrostatic capacity of the biochip changes according to the reaction of the probe molecule and the injected target molecule.

5. The biosensor of claim 4, wherein a degree of reaction of the biochip is quantified according to a charging time.

6. The biosensor of claim 1, further comprising:
a switch located between the biochip and the touch panel.

7. The biosensor of claim 6, wherein the switch is switched by light generated by a liquid crystal display (LCD) of the touch panel.
